(19) United States
(12) Patent Application Publication
(10) Pub. No.: US 2015/0363764 A1
(43) Pub. Date: Dec. 17, 2015

(54) PERSON-TO-PERSON (P2P) PAYMENTS VIA A SHORT-RANGE WIRELESS PAYMENT BEACON

(71) Applicant: Bank of America Corporation, Charlotte, NC (US)

(72) Inventors: David M. Grigg, Rock Hill, SC (US); James Gregory Ronca, Decatur, GA (US); Henry J. Chou, Cornelius, NC (US); Joseph Neil Johansen, Rock Hill, SC (US); Michael E. Toth, Charlotte, NC (US); Elizabeth S. Votaw, Potomac, MD (US)

(21) Appl. No.: 14/457,940

(22) Filed: Aug. 12, 2014

Related U.S. Application Data
(60) Provisional application No. 62/012,747, filed on Jun. 16, 2014.

(51) Int. Cl. G06Q 20/32; G06Q 20/38; G06Q 20/20

(52) U.S. Cl. CPC G06Q 20/327; G06Q 20/20; G06Q 20/3821

(57) ABSTRACT

Systems, apparatus, and computer program products are provided for conducting person-to-person (P2P) payments via a short-range wireless payment beacon.

### CROSS-REFERENCE TO RELATED APPLICATIONS

This application claims priority to U.S. Provisional Patent Application Ser. No. 62/012,747, filed Jun. 16, 2014, entitled “Person-to-Person (P2P) Payments via a Short-Range Wireless Payment Beacon,” the entirety of which is incorporated herein by reference.

### INCORPORATION BY REFERENCE

To supplement the present disclosure, this application further incorporates entirely by reference the following commonly assigned patent application entitled, “A Widget for Promoting Payments via a Person-to-Person (P2P) Payment Rail”, Attorney Docket No. 6318US1.014033.2283, U.S. patent application Ser. No. ______, filed concurrently herewith.

### FIELD

In general, embodiments of the invention relate to commerce and, more particularly, to conducting person-to-person (P2P) payments via a short-range wireless payment beacon.

### BACKGROUND

Small businesses, charities or the like are always looking for ways to make payment easier for customers and/or donors and at the same time defer costs. While customers/donors have typically chosen to make such payments/donations with a credit card, the business or charity bares the financial fee associated with accepting such credit card payments.

In one specific example, when a large event, charity or otherwise, is held that requires an admission fee or the like, attendees/customers typically have to wait in line in order to pay the admission fee or make any other payment associated with the event.

Therefore, a need exists to develop systems, apparatus, methods, computer program products and the like that make it convenient for event attendees to make payments/donations, while maximizing the profitability for the business or charity conducting the event.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, computer program products or the like for conducting Person-to-Person (P2P) payments, otherwise referred to as account-to-account payments or direct bank account payments, via the use of short-range wireless payment beacons that serve as the Point-of-Sale (POS) device for the payment transaction.

In such embodiments of the invention, the payment beacon communicates a short range wireless communication, such as a low energy Bluetooth communication, infrared, Near Field Communication (NFC), Wi-Fi or the like that announces the presences of a payment beacon in the proximity area (i.e., at an event, within the confines of an predetermined area, a building or the like). Computing devices, such as mobile communication devices (i.e., smart telephones, tablets or the like) in the range of the short-range wireless communication that are configured to receive such notifications, may initiate a secured wireless communication channel with the payment beacon and communicate a P2P payment request including payment credentials and, in some embodiments, a payment amount to the payment beacon. In response to receiving the P2P payment request, the payment beacon forwards the request to a P2P payment processing module, which validates the user (i.e., P2P payment payor), determines the payment account, in some embodiments determines the payee account and processes immediate remittance of the payment amount from the payment account to the payee account.

As such, the present invention affords customers/donors an easy option for making payments/donations when within the vicinity of a payment beacon, such as at an event or the like, and provides the business/charity with an alternative payment rail (i.e., P2P/account-to-account payment) that may lessen or eliminate the fees associated with accepting credit card payments or the like.

A system for executing a person-to-person (P2P) payment defines first embodiments of the invention. The system includes a mobile communication device having a computing platform including a memory and at least one processor in communication with the memory. The memory of the mobile communication device includes a short-range wireless person-to-person (P2P) payment application that is executable by one of the processors of the mobile communication device. The application is configured to detect, via short-range wireless communication, such as low-energy 2.4 to 2.485 GHz radio band communication, Wi-Fi communication, near field communication, infrared communication or the like, a payment beacon, which is located in the vicinity of the mobile communication device. In response to detecting the payment beacon and the user selecting the payment beacon, the application is configured to establish a secure wireless communication channel between the mobile device and the payment beacon. The application is further configured to receive a user-input that defines the user's P2P payment credentials, e.g., user identification and passcode/password or the like, and in some embodiments of the invention, a payment amount (in other embodiments of the invention the payment amount may be a fixed payment amount configured by the payment beacon). Further, the application is configured to generate a payment request, which is communicated to the payment beacon through the secured wireless communication channel and includes the payment credentials, and in some embodiments, the payment amount.

The system further includes a Point-Of-Sale (POS) payment beacon device that includes a computing platform having a memory and at least one processor in communication with the memory. The payment beacon may be a mobile communication device (e.g., table, laptop computer, smart telephone or the like) or the payment beacon may be a more stationary computing device, such as POS cash register, PC or the like. The memory of the payment beacon device stores a POS short-range wireless P2P payment promotion application that is executable by one of the processors of the POS payment beacon device. The POS short-range wireless P2P payment application is configured to communicate a short-range wireless signal (e.g., low energy, 2.4 to 2.485 band, NFC, Wi-Fi, infrared or the like) that is configured to notify computing devices that are proximate in location and executing the short-range wireless person-to-person (P2P) payment application of the presence of the payment beacon device. Further, the POS short-range wireless P2P payment application is configured to receive the P2P payment request via the secured wireless communication channel and initiate communication of the P2P payment request to a P2P payment processing module that is executed at a server or the like.

In addition, the system includes a P2P payment processing server having a computing platform including a memory and at least one processor in communication with the memory. The memory of the server stores a P2P payment processing module that is executable by one of the processors of the server. The P2P payment processing module is configured to receive the payment request communicated from the beacon device, validate the user as a registered P2P payment participant based on the P2P payment credentials, determine/identify the payment account designated by the user for paying the payment amount, determine a payee account for receiving the payment amount, and initiate immediate remittance of the payment amount from the payment account to the payee account.

A computer program product including a non-transitory computer-readable medium defines second embodiments of the invention. The computer-readable medium includes a first set of codes for causing a mobile communication device to detect, via short-range wireless communication, a payment beacon. Additionally, the computer-readable medium includes a second set of codes for causing the mobile communication device to, in response to detecting the payment beacon, initiate a secured wireless communication channel between the payment beacon and the mobile communication device. In addition, the computer-readable medium includes a third set of codes for causing the mobile communication to receive a user input that defines P2P payment credentials of the user. Moreover, the computer-readable medium includes a fourth set of codes for causing the mobile communication device to initiate electronic communication, to the payment beacon via the secured wireless communication channel, of a P2P payment request that includes the P2P payment credentials.

In alternate embodiments of the computer program product, the computer-readable medium addition includes a fifth set of codes for causing the payment beacon to receive the P2P payment request via the secured wireless communication channel and a sixth set of codes for causing the payment beacon to initiate communication of the P2P payment request to a P2P payment processing server.

In still further alternate embodiments of the computer program product the computer-readable medium includes a seventh set of codes for causing the P2P payment processing server to receive the payment request communicated from the beacon device and an eighth set of codes for causing the P2P payment processing server to validate the user as a registered P2P payment participant based on the P2P payment credentials. Moreover, the computer-readable medium includes a ninth set of codes for causing the P2P payment processing server to determine the payment account designated by the user for paying the payment amount and a tenth set of codes for causing the P2P payment processing server to determine a payee account for receiving the payment amount. In addition, the computer-readable medium includes an eleventh set of codes for causing the P2P payment processing dse4rver to initiate immediate remittance of the payment amount from the payment account to the payee account.

A method executing a person-to-person (P2P) payment defines third embodiments of the invention. The method includes detecting, by a mobile communication device, via short-range wireless communication, a payment beacon and, in response to detecting the payment beacon, initiating, by the mobile communication device, establishment of a secured wireless communication channel between the payment beacon and the mobile communication device. The method further includes receiving, by the mobile communication device, a user input that defines P2P payment credentials of the user; and initiating, by the mobile communication device electronic communication, to the payment beacon via the secured wireless communication channel, of a P2P payment request that includes the P2P payment credentials.

In alternate embodiments the method further includes receiving, by a payment beacon device, the P2P payment request via the secured wireless communication channel, and initiating, by the payment beacon device, communication of the P2P payment request to a P2P payment processing server.

In still further embodiments the method includes receiving, by a P2P payment processing server, the payment request communicated from the beacon device and validating, by the P2P payment processing server, the user as a registered P2P payment participant based on the P2P payment credentials. Further, the alternate method includes determining, by the P2P payment processing server, the payment account designated by the user for paying the payment amount and determining, by the P2P payment processing server, a payee account for receiving the payment amount. In addition, the alternate method includes initiating, by the P2P payment processing server, immediate remittance of the payment amount from the payment account to the payee account.

Thus, systems, apparatus, methods, and computer program products herein described in detail below provide for conducting person-to-person (P2P) payments via a short-range wireless payment beacon.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of a system configured for conducting person-to-person (P2P) payments via a short-range wireless payment beacon, in accordance with embodiments of the present invention; and

FIG. 2 provides a schematic diagram of a system configured for conducting person-to-person (P2P) payments via a short-range wireless payment beacon, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for conducting Person-to-Person (P2P) payments, otherwise referred to as account-to-account payments or direct bank account payments, via the use of short-range wireless payment beacons that serve as the Point-of-Sale (POS) device for the payment transaction.

In such embodiments of the invention, the payment beacon communicates a short range wireless communication, such as a low energy Bluetooth communication, infrared, Near Field Communication (NFC), Wi-Fi or the like that announces the presences of a payment beacon in the proximity area (i.e., at an event, within the confines of a building or the like). Computing devices, such as mobile communication devices (i.e., smart telephones, tablets or the like) in the range of the short-range wireless communication that are configured to receive such notifications, may initiate a secured wireless communication channel with the payment beacon and communicate a P2P payment request including payment credentials and, in some embodiments, a payment amount to the payment beacon. In response to receiving the P2P payment request, the payment beacon forwards the request to a P2P payment processing module, which validates the user (i.e., P2P payment payor), determines the payment account, in some embodiments determines the payee account and processes immediate remittance of the payment amount from the payment account to the payee account.

As such, the present invention affords customers/donors an easy option for making payments/donations when within the vicinity of a payment beacon, such as at an event or the like, and provides the business/charity with an alternative payment rail (i.e., P2P/account-to-account payment) that may lessen or eliminate the fees associated with accepting credit card payments or the like.

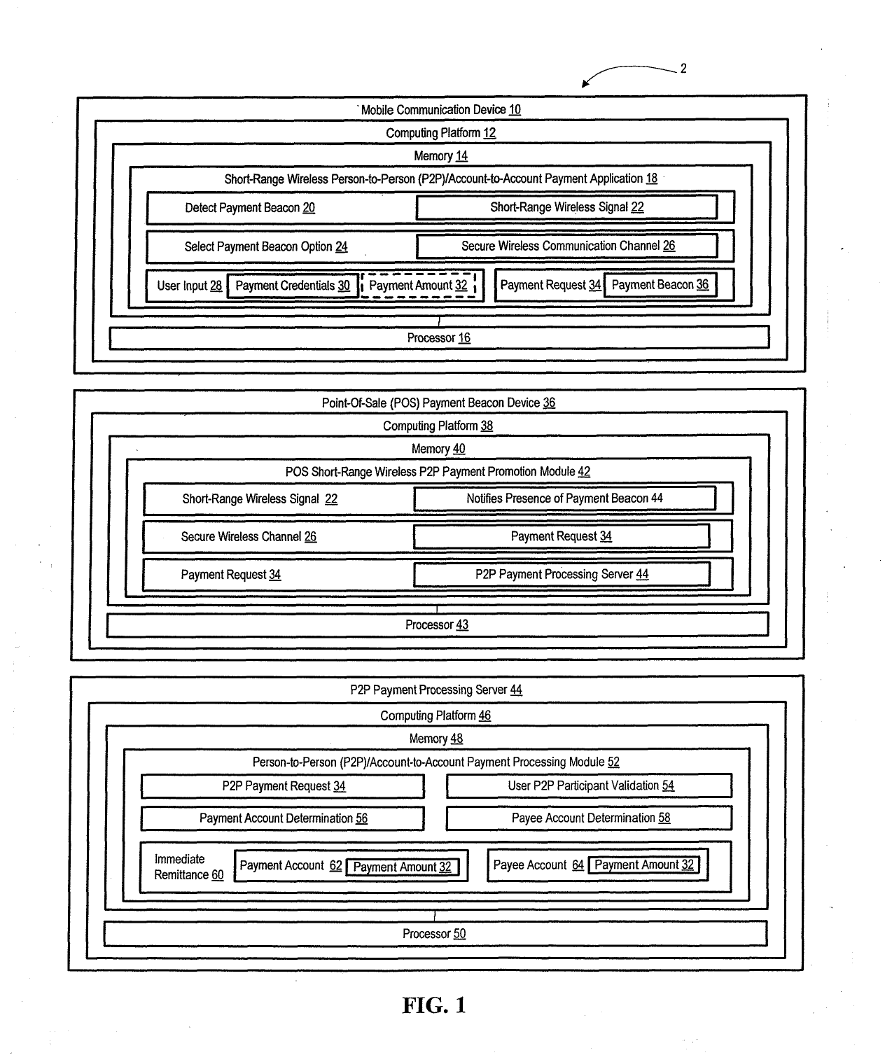

Referring to FIG. 1, block diagram is presented of a system 2 that includes mobile communication device 10, a P2P payment beacon device 36 and a P2P payment processing server 44 configured for conducting person-to-person (P2P) payments via a short-range wireless payment beacon, in accordance with embodiments of the present invention. The devices or apparatus in system 2 are operable to receive and execute modules, routines and applications, such as short-range wireless P2P payment application 18, POS short-range wireless P2P payment promotion module 42 and P2P payment processing module 52 and the like.

The devices in the system include computing platforms 12, 38 and 46 that can receive and execute routines and applications. The computing platforms 12, 38 and 46 include memory 14, 40 and 48, which may comprise volatile and nonvolatile memory such as read-only and/or random-access memory (RAM and ROM), EPROM, EEPROM, flash cards, or any memory common to computer platforms. Further, memory 14, 40 and 48 may include one or more flash memory cells, or may be any secondary or tertiary storage device, such as magnetic media, optical media, tape, or soft or hard disk.

Further, the computing platforms 12, 38 and 46 also includes at least one processor 16, 43 and 50 which may be an application-specific integrated circuit (“ASIC”), or other chipset, processor, logic circuit, or other data processing device. Processor 16, 43 and 50 or other processor such as ASIC may execute an application programming interface (“API”) layer (not shown in FIG. 1) that interfaces with any resident programs, such as short-range wireless P2P payment application 18, POS short-range wireless P2P payment promotion module 42, P2P payment processing module 52 and the like, stored in the memory 14, 40 and 48 of devices 10, 36 and 44. Processor 16, 43 and 50 includes various processing subsystems (not shown in FIG. 1) embodied in hardware, firmware, software, and combinations thereof, that enable the functionality of the system and the operability of the devices on an electronic network. For example, processing subsystems allow for initiating and maintaining communications, and exchanging data, with other networked devices. Additionally, processing subsystems may include any portion of the functionality of short-range wireless P2P payment application 18, POS short-range wireless P2P payment promotion module 42 and P2P payment processing module 52 obviating the need for such applications and modules to be stored in the memory 14, 40 and 48.

The memory 14 of mobile communication device 10 stores short-range wireless Person-to-Person (P2P) payment application 18. The P2P payment application is configured to receive a short-range wireless signal 22 that detects the presence 20 of a payment beacon 36. The short-range wireless signal 22 that is detected is based on the configuration of the application and the capabilities of the mobile communication device 10. For example, the short-range wireless signal 22 may be a low energy Bluetooth signal (i.e., a signal operating in the 2.4 to 2.485 GHz radio band), a NFC signal, a Wi-Fi signal, an infrared signal or the like. The signal 22 may take the form of an alert displayed on the mobile communication device 10. In those instances in which the wireless communication device does not include the P2P payment application 18 but is configured to receive the short wireless communication communicated form the POS payment beacon device 36, the receipt of the wireless signal 22 that notifies presence of the payment beacon 44 may provide instructions for downloading the P2P payment application and/or registering for P2P payment processing (e.g., linking one or more of the user's payment accounts to an identifier and defining payment credentials 30).

The payment application 18 is further configured, in response to receiving signal 22, to receive a user input that selects the payment beacon 24 and, in response to receiving the user input, establishing a secure wireless communication channel 26 between the mobile communication device 10 and the payment beacon 36. The secure wireless communication channel 26 provides for communication of encrypted data or other means to insure against the data being intercepted and deciphered by non-authorized entities.

Moreover, the short-range wireless Person-to-Person (P2P) payment application 18 is configured to receive a user input 28 that defines the user's preconfigured P2P payment credentials 30, such as user identification (ID) and passcode/password and, in some embodiments of the invention, a payment amount 32. It should be that in certain instances the payment amount will be a fixed amount associated with the payment beacon, such as when the payment beacon is set-up for payment of a fixed admission charge or participation charge for an event or the like. In such instances the user need not provide an input that defines the payment amount.

In response to receiving the user input 28, the payment application 18 is configured to initiate communication, via the secured wireless communication channel to the payment beacon 36, of a P2P payment request 34 that includes the payment credentials 30 and, in some embodiments, the payment amount 32.

The system additionally includes the POS P2P payment beacon device 38 that stores in memory 40 the POS short-range wireless P2P payment promotion module 42. The module 42 is configured to communicate the short-range wireless signal 22 that notifies computing devices, especially mobile communication devices, of the presence 44 of the payment beacon. The module 42 is further configured to receive the P2P payment request 34 from the mobile communication device 10 via the secure wireless communication channel 26. In turn, the P2P payment beacon device 38 is configured to forward the payment request 34 to the P2P payment processing server 44 for subsequent P2P payment processing. In addition, the payment beacon 38 may augment the payment request 34 to include the payee (e.g., the payment beacon-provider), the payee account or other payment attribute data.

The system additionally includes P2P payment processing server 44 that stores in memory 48 P2P payment processing module 52. The P2P payment processing module 52 is configured to receive the P2P payment request 34 and, through use of the payment credentials 30, validate 54 the user as a previously registered (or newly registered) P2P payment participant. Once validated, the payment processing module 52 is further configured to determine the payment account 62 designated by the P2P payment user from which the payment amount 32 is to be drawn from. Determination of the payment account 62 may be based on a payment account priority preconfigured by the user. Additionally, determination of the payment account 62 may be based on the type of payment as preconfigured by the user (e.g., charity payments from account(s) “x” and purchase payments from account(s) “y”).

P2P payment processing module 40 is further configured to determine the payee account(s) 58 for receiving the payment amount 32. As previously noted in specific embodiments the payment beacon is payee-specific (i.e., specific business, specific charity, specific event, or the like). As such, the payment beacon that forwards the payment request 34 to the server 44 may serve to identify the payee and, if the payee has only one account designated for receiving the payment amount 32, the payment request 34 may, de facto, identify the payee account 64, as well. Additionally, as previously discussed, the payment request 34 may include a payee account identifier (not shown in FIG. 1) or payment attribute data (not shown in FIG. 1), which may include a payee account identifier. In other embodiments of the invention, the determination of the payee account 64 may be made by the module 42 at the payment beacon 36 or the server 44 in conjunction with a P2P payment cloud (not shown in FIG. 1). In such embodiments, the P2P payment processing module 52 may rely on payment attribute data received from the beacon device 36 to determine the payor, the purpose/type of payment (e.g. charity, purchase, event or the like) or the like and, using correlation tables stored at the server 44 or in the cloud, identify the payee account 64 associated with the payee (i.e., payment beacon-provider), the purpose/type of payment or the like.

Once the payment account 62 and the payee account 64 have been determined, P2P payment processing module 52 is further configured to initiate immediate remittance 60 of the payment amount 32 from the payment account(s) 62 to the payee account 64. Immediate remittance 60 provides for the payment amount 32 to be debited from the payment account 62 upon receiving the payment request 34 and validating 54 the user as the P2P payment participant and for the payee account 64 to receive and have available (i.e., no hold period) the payment amount 32 instantaneously upon completion of the P2P payment process. In addition, a notification may be communicated from the payment beacon device 36 to the mobile communication device 10 that serves a payment receipt and/or an admission ticket to the event or the like.

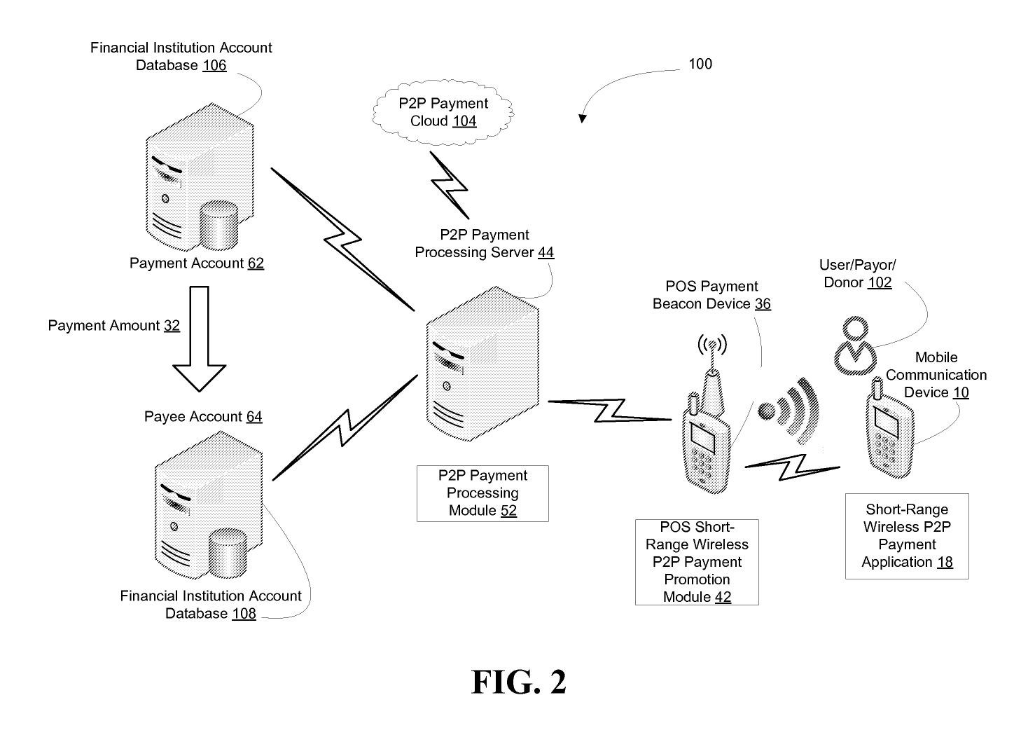

Referring to FIG. 2 a schematic diagram is provided of a system 100 for conducting P2P payment using a short-range wireless payment beacon, in accordance with embodiments of the present invention. The system 100 includes a POS P2P payment beacon device 36 that stores POS short-range wireless P2P payment promotion module 42 that is configured to broadcast the payment beacon's presence to computing devices, such as mobile communication device 10 that are within the range of the short-range wireless communication signal. As depicted the payment beacon device may take the form of a mobile device, such as a smart telephone, laptop, tablet or the like or, in other embodiments, the payment beacon device may be a stationary device, such as a POS register, a PC or the like.

The system additionally includes mobile communication device 10 that receives the short-range wireless communication through P2P payment app 18 and selects the payment beacon for initiating P2P payment. In this regard, the user 102 of the mobile communication device 10 executes short-range wireless P2P payment app 18 to establish a secure communication channel/link with the payment beacon device 36, receive P2P payment credentials and communicate a payment request to the beacon device 26 via the secure communication channel.

In turn, the payment beacon device 36 communicates the payment request to P2P payment processing server 44 which, in concert with P2P payment cloud 104, executes P2P payment processing module 52. As previously, noted the payment processing module 52 receives the payment request from the payment beacon device and validates the user as a registered P2P payment participant and determines the payment account designated by the user and the payee account designated by the payee (e.g., the payment beacon-provider). The user credentials, the payment account information and, in some embodiments, the payee account information used to correspondingly validate the user, and determine payment account(s) and payee accounts(s) may be stored in the P2P payment cloud 104.

Once the payment request has been processed by the P2P payment processing module 52 (i.e., the user is validated and payment and payee accounts have been identified), immediate remittance of the payment amount 32 occurs. The financial institution account database 106 associated with the payment account 62 is accessed to debit the payment amount 32 from the payment account 62 and the financial institution account database 108 associated with the payee account 64 is accessed to credit the payment amount 32 to the payee account 64. Immediate remittance provides for no delay time or hold time between debiting the payment amount 32 from the payment account 62 and crediting the payee account 64.

Thus, systems, apparatus, methods, and computer program products described above provide for provide for conducting person-to-person (P2P) payments via a short-range wireless payment beacon.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for executing a person-to-person (P2P) payment, the system comprising:
a mobile communication device having a memory and at least one processor in communication with the memory;
a short-range wireless person-to-person (P2P) payment application stored in the memory of the mobile communication device, executable by one of the processors of the mobile communication device and configured to (1) detect, via short-range wireless communication, a payment beacon, (2) in response to detecting the payment beacon, initiate a secured wireless communication channel between the payment beacon and the mobile communication device, (3) receive a user input that defines P2P payment credentials of the user, and (4) initiate electronic communication, to the payment beacon, of a P2P payment request that includes the P2P payment credentials;
a Point-Of-Sale (POS) payment beacon device having a memory and at least one processor in communication with the memory;
a POS short-range wireless P2P payment promotion application stored in the memory of the POS payment beacon device, executable by one of the processors of the POS payment beacon device and configured to (1) communicate a short-range wireless signal that is configured to notify computing devices executing the short-range wireless person-to-person (P2P) payment application of the presence of the beacon device, (2) receive the P2P payment request via the secured wireless communication channel, and (3) initiate communication of the P2P payment request to a P2P payment processing server;
the P2P payment processing server having a memory and at least one processor in communication with the memory;
a P2P payment processing module stored in the memory of the server, executable by one of the processors of the server and configured to (1) receive the payment request communicated from the beacon device, (2) validate the user as a registered P2P payment participant based on the P2P payment credentials, (2) determine the payment account designated by the user for paying the payment amount, (3) determine a payee account for receiving the payment amount, and (4) initiate immediate remittance of the payment amount from the payment account to the payee account.

2. The system of claim 1, wherein the short-range wireless P2P payment application is further configured to, in response to detecting the payment beacon, display on the mobile communication device an alert that notifies the user of the presence of the POS payment beacon deacon.

3. The system of claim 1, wherein the short-range wireless P2P payment application is further configured to receive a user input that initiates the secured wireless communication channel between the payment beacon and the mobile communication device.

4. The system of claim 1, wherein the short-range wireless P2P payment application is further configured to receive the user input that defines the P2P payment credentials of the user and a payment amount and initiate electronic communication, to the payment beacon, of the P2P payment request that includes the P2P payment credentials and the payment amount.

5. The system of claim 1, wherein the POS short-range wireless P2P payment promotion application is further configured to communicate the short-range wireless signal that is configured to notify computing devices executing the short-range wireless person-to-person (P2P) payment application of the presence of the beacon device, wherein the short-range wireless signal is one of a signal operating in the 2.4 to 2.485 GHz radio band, an NFC signal, a Wi-Fi signal, or an infrared signal.

6. The system of claim 1, wherein the POS short-range wireless P2P payment promotion application is further configured to communicate a second short-range wireless signal that is configured to notify computing devices capable of receiving the short-range wireless signal of at least one of (1) presence of the payment beacon, (2) instructions for downloading the short-range wireless person-to-person (P2P) payment application or (3) instructions for registering as a P2P payment participant.

7. The system of claim 1, wherein the POS short-range wireless P2P payment promotion application is further configured initiate communication of the P2P payment request and payment attribute data to a P2P payment processing server.

8. The system of claim 1, wherein the P2P payment processing module is further configured to determine a payee account for receiving the payment amount based on the payment attribute data.

9. A computer program product comprising:
a non-transitory computer-readable medium comprising:
a first set of codes for causing a mobile communication device to detect, via short-range wireless communication, a payment beacon;
a second set of codes for causing the mobile communication device to, in response to detecting the payment beacon, initiate a secured wireless communication channel between the payment beacon and the mobile communication device;
a third set of codes for causing the mobile communication to receive a user input that defines P2P payment credentials of the user; and
a fourth set of codes for causing the mobile communication device to initiate electronic communication, to the payment beacon via the secured wireless communication channel, of a P2P payment request that includes the P2P payment credentials.

10. The computer program product of claim 9, further comprising:
a fifth set of codes for causing the payment beacon to receive the P2P payment request via the secured wireless communication channel; and
a sixth set of codes for causing the payment beacon to initiate communication of the P2P payment request to a P2P payment processing server.

11. The computer program product of claim 10, further comprising:
a seventh set of codes for causing the P2P payment processing server to receive the payment request communicated from the beacon device;
an eighth set of codes for causing the P2P payment processing server to validate the user as a registered P2P payment participant based on the P2P payment credentials;
a ninth set of codes for causing the P2P payment processing server to determine the payment account designated by the user for paying the payment amount;
a tenth set of codes for causing the P2P payment processing server to determine a payee account for receiving the payment amount; and
an eleventh set of codes for causing the P2P payment processing dse4rver to initiate immediate remittance of the payment amount from the payment account to the payee account.

12. The computer program product of claim 9, wherein the first set of codes is further configured to cause the mobile communication device to, in response to detecting the payment beacon, display on the mobile communication device an alert that notifies the user of the presence of the POS payment beacon deacon.

13. The computer program product of claim 9, wherein the second set of codes is further configured to cause the mobile communication device to receive a user input that initiates the secured wireless communication channel between the payment beacon and the mobile communication device.

14. The computer program product of claim 9, wherein the third set of codes is further configured to cause the mobile communication device to receive the user input that defines the P2P payment credentials of the user and a payment amount and the fourth set of codes is further configured to cause the mobile communication device to initiate electronic communication, to the payment beacon, of the P2P payment request that includes the P2P payment credentials and the payment amount.

15. The computer program product of claim 9, wherein the first set of codes is further configured to cause the mobile communication device to detect, via the short-range wireless communication, the payment beacon, wherein the short-range wireless communication is one of communication operating in the 2.4 to 2.485 GHz radio band, Near Field Communication (NFC), Wi-Fi communication, or infrared communication.

16. The computer program product of claim 10, further comprising a seventh set of codes for causing the payment beacon to communicate a short-range wireless signal that is configured to notify computing devices capable of receiving the short-range wireless signal of at least one of (1) presence of the payment beacon, (2) instructions for downloading the short-range wireless person-to-person (P2P) payment application or (3) instructions for registering as a P2P payment participant.

17. A method for executing a person-to-person (P2P) payment, the method comprising:
detecting, by a mobile communication device, via short-range wireless communication, a payment beacon;
in response to detecting the payment beacon, initiating, by the mobile communication device, establishment of a secured wireless communication channel between the payment beacon and the mobile communication device;
receiving, by the mobile communication device, a user input that defines P2P payment credentials of the user; and
initiating, by the mobile communication device electronic communication, to the payment beacon via the secured wireless communication channel, of a P2P payment request that includes the P2P payment credentials.

18. The method of claim 18, further comprising:
receiving, by a payment beacon device, the P2P payment request via the secured wireless communication channel; and
initiating, by the payment beacon device, communication of the P2P payment request to a P2P payment processing server.

19. The method of claim 19, further comprising:
receiving, by a P2P payment processing server, the payment request communicated from the beacon device;
validating, by the P2P payment processing server, the user as a registered P2P payment participant based on the P2P payment credentials;
determining, by the P2P payment processing server, the payment account designated by the user for paying the payment amount;
determining, by the P2P payment processing server, a payee account for receiving the payment amount; and
initiating, by the P2P payment processing server, immediate remittance of the payment amount from the payment account to the payee account.
